(19) United States
(12) Patent Application Publication
(10) Pub. No.: US 2009/0059209 A1
(43) Pub. Date: Mar. 5, 2009

(54) LOCK-IN DEMODULATION TECHNIQUE FOR OPTICAL INTERROGATION OF A GRATING SENSOR

(76) Inventors: An-Dien Nguyen, Fremont, CA (US); Hong Jiao, Santa Clara, CA (US)

Correspondence Address: SCHNECK & SCHNECK, P.O. BOX 2-E, SAN JOSE, CA, 95109-0005, US

(21) Appl. No.: 12/201,256

(22) Filed: Aug. 29, 2008

Related U.S. Application Data
(60) Provisional application No. 60/970,018, filed on Sep. 5, 2007.

(51) Int. Cl. G01N 21/01

(52) U.S. Cl. 356/73.1

(57) ABSTRACT

A grating sensor and method for optical interrogation of that sensor uses a lock-in technique to achieve simultaneous measurements of strain (and related temperature) and ultrasonic stress wave signals, as well as other environmental conditions that affect a reflection spectrum of the grating sensor. It achieves this by using a lock-in amplifier or a software demodulator to detect slight shifts in the grating reflection spectrum with high sensitivity and accuracy. A dynamic feedback loop based on the lock-in error signal output retunes the light wavelength of the light source (e.g., a tunable laser) or of a wavelength filter in the reflection path to maintain it relative to a specified reflection point of the grating reflector. The lock-in error signal serves as a measure of temperature/strain changes and of ultrasonic vibrations.

### CROSS-REFERENCE TO RELATED APPLICATION

This patent application claims priority under 35 U.S.C. §119(e) from prior U.S. provisional application 60/970,018 filed Sep. 5, 2007.

### STATEMENT REGARDING FEDERALLY SPONSORED RESEARCH AND DEVELOPMENT

This invention was made with government support under SBIR contract number NND07AA04C awarded by the National Aeronautics and Space Administration (NASA). The government has certain rights in the invention.

### TECHNICAL FIELD

The present invention relates to optical measuring and testing of strain, ultrasonic stress waves, and temperature using optical interrogation of a grating sensor, such as tunable laser interrogation of a fiberoptic waveguide with Bragg grating reflector.

### BACKGROUND ART

Laser-based fiber Bragg grating (FBG) interrogation techniques have long been used commercially for strain monitoring [Rose, J., Ultrasonic Waves in Solid Media, Cambridge University Press, 1999]. More recently, a number of FBG interrogation techniques have been proposed for ultrasonic wave monitoring and other structural health monitoring applications [W. Prosser, M. Gorman and J. Dorighi, “Extensional and Flexural Waves in a Thin-Walled Graphite/Epoxy Tube”, J. Compos. Mat. 26:418 (1992); M. Gorman and W. Prosser, “AE Source Orientation by Plate Wave Analysis”, J. Acoustic Emission 9:283 (1991)]. In a standard FBG interrogation technique, light from a tunable laser is typically tuned to the mid-reflection wavelength of the Bragg grating, and the reflected light is detected by a photodetector, which converts the light signal to an electrical signal. As the sensing grating experiences loads, dynamic strain, or acoustic fields, the Bragg reflection wavelength shifts, causing the reflected intensity from the Bragg grating to change. The DC to low-frequency AC signal corresponds to static and quasistatic strain, while a higher frequency AC signal corresponds to dynamic strain or ultrasonic stress waves. The signal amplitude (sensitivity) is directly proportional to the slope of the Bragg reflection spectrum.

To date, no single laser-based FBG interrogation technique has been developed that reliably and simultaneously monitors both strain and ultrasonic waves with both high strain resolution and high stress wave sensitivity. High strain resolution and high stress wave sensitivity require that the slope of the Bragg reflectivity spectrum of a fiber Bragg grating be as steep as possible. However, the steeper the FBG slope, the more sensitive the reflection signal to environmental changes. As a result, these laser-based FBG interrogation techniques lack the robustness and sensitivity required for long-term strain and ultrasonic wave detection for damage detection of structures in harsh environments.

### SUMMARY OF DISCLOSURE

A grating sensor and a corresponding method for optical interrogation of the grating sensor have been developed which use an AC lock-in technique to measure a variety of environmental conditions with sensitivity and accuracy. A grating reflector is optical coupled to receive light from a light source, such as a wavelength tunable laser, or an intensity modulated broadband light source. The grating reflector is characterized by a reflection spectrum that is dependent upon environmental conditions. In the case of a tunable laser, the coupled light wavelength may be dithered about a selected reflection wavelength of the grating, such as a peak reflection wavelength or along one of the slopes of the spectrum. The grating reflector may be a Bragg grating formed in an optical fiber or may be a surface-relief grating. In any case, the reflected light from the grating is coupled to a photo-detector which produces an electrical signal corresponding to the light intensity that it receives. In the case of a broadband light source, a tunable wavelength filter is positioned in the reflection path in front of the photo-detector to select the wavelength to be received and detected.

The sensor also includes a lock-in system, which may be either a hardware lock-in amplifier or a corresponding software demodulator of the signal. In either form, the lock-in mechanism picks out the dithering signal at a given reference frequency to get rid of around 90% of the noise, enabling the system to lock-in the wavelength of the laser source or of the wavelength filter at a specified point in the grating's spectrum. The lock-in mechanism provides feedback to the light source or filter to retune it to the specified reflection wavelength of the grating. For example, a tunable semiconductor laser may be tuned via either temperature or current control, or both. The lock-in error signal also serves as a measure of the environmental conditions to which the sensor is subject.

In one particular implementation of the invention, in order to achieve both the sensitivity and accuracy required for simultaneous measurements of strain, temperature, and ultrasonic stress wave signals, a laser demodulation technique for FBG interrogation based upon a simple lock-in scheme integrates the laser control electronics and photo-detector signals together in a dynamic feedback loop circuit to provide stable laser wavelength locking to the Bragg wavelength of the FBG sensors. For strain measurements, a sub-microstrain resolution requires picometer wavelength-shift detection sensitivity, which is often obscured by environmental and system noise. To effectively remove the noise contribution, the output signal of the photodetector is fed into a commercial lock-in amplifier, which in turn provides a feedback signal for laser control electronics. This lock-in scheme enables the laser wavelength to be continuously locked to the stable point at the mid-reflection wavelength of the Bragg grating to produce the highest signal-to-noise, providing a direct strain measurement via the generated error signal. Due to the out-of-band noise rejection by the lock-in amplifier, the resulting signal to noise ratio is greatly enhanced, permitting sub-microstrain detection sensitivity. Once the laser is locked, the DC strain signal is very stable, and laser wavelength is highly resistant to environmental noise that tends to move the laser wavelength away from the stable point it is locked to, enabling both improved signal-to-noise strain measurements and reliable AC strain and stress wave detection.

This lock-in laser-based demodulation technique interrogating optical waveguide Bragg gratings (BG) provides simultaneous, reliable, high resolution, high sensitivity measurements of strain, temperature, stress, acoustic emission, and ultrasonic wave detection. The lock-in scheme integrates the laser control electronics and photo-detector signals together in a dynamic feedback loop circuit to provide stable laser wavelength locking to the Bragg wavelength of the BG sensors. Using this technique, detection of sub-microstrain resolution by the lock-in based FBG interrogation system can be routinely obtained while the system simultaneously monitors ultrasonic stress waves with high sensitivity and reproducibility. Due to the high noise rejection, inherent self-reference, and robust wavelength locking capabilities, the lock-in strain signal output and the laser wavelength tracking are extremely stable and are immune of optical power fluctuations due to system and environmental noise.

### BRIEF DESCRIPTION OF THE DRAWINGS

FIG. 1 is a schematic of an experimental setup of an FBG sensor using the lock-in laser-based FBG interrogation technique in accord with the present invention for performing strain and ultrasonic wave measurements.

FIG. 2 is a graph of lock-in error voltage signal from measuring FBG temperature-induced strain over a 17-hour timeframe using the setup of FIG. 1, and, for comparison, a temperature monitoring signal (in degrees Celsius) from a Thorlab temperature controller monitor recorded over the same timeframe.

FIGS. 3a and 3b are graphs of FBG sensor dynamic response (in Volts over about 250 μs) to 10-cycle sine tone burst stress waves on a carbon fiber composite plate in the setup of FIG. 1, at respective times (a) t=0 and (b) t=17 hours, while the laser is locked to the FBG's mid-reflection wavelength and the temperature-induced strain data is continuously recorded.

FIG. 4 is a schematic of an alternative grating sensor using a software lock-in system.

FIG. 5 is a schematic of an alternative grating sensor using a broadband light source.

### DETAILED DESCRIPTION

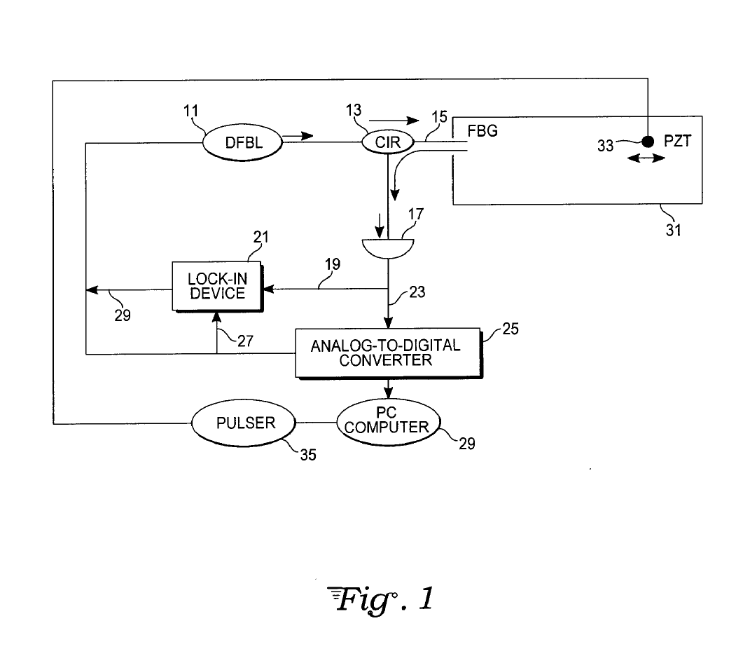

With reference to FIG. 1, feasibility of the laser lock-in based FBG interrogation technique of the present invention is demonstrated in the illustrated experimental setup by locking a commercial tunable distributed feedback (DFB) laser to a commercial FBG sensor to simultaneously obtain sub-microstrain resolution and high sensitivity ultrasonic wave detection with high reproducibility and stability over a period of time, from a few hours to a few weeks.

As seen in FIG. 1, a distributed feedback (DFB) tunable semiconductor laser 11 (with associated control electronics) is optically coupled to supply laser light to an FBG sensor 15 via a beamsplitter 13. Other wavelength tunable light sources or even broadband light sources could be used. Here the FBG sensor 15 is an optical fiber with a Bragg grating formed therein. The optical fiber material may be silica, fluorozirconate glass, a polymer, or any other material that is transparent at the wavelengths of interest and can serve as a waveguide to the grating. The selection of the material may be optimized to be sensitive to the environmental conditions that are desired to be measured. For example, for stress measurement, a softer material (smaller Young's modulus) would be better. The Bragg grating may be constructed to have a high reflectivity slope in its spectrum for good dynamic range. The grating reflector changes its reflection spectrum, either by a change of reflective index of the material in which the light is guided or by a change in the grating pitch or spacing. Instead of a Bragg grating formed in an optical fiber or other waveguide, a surface-relief grating could be used, where changes in environmental conditions change the grating pitch e.g., by thermal expansion.

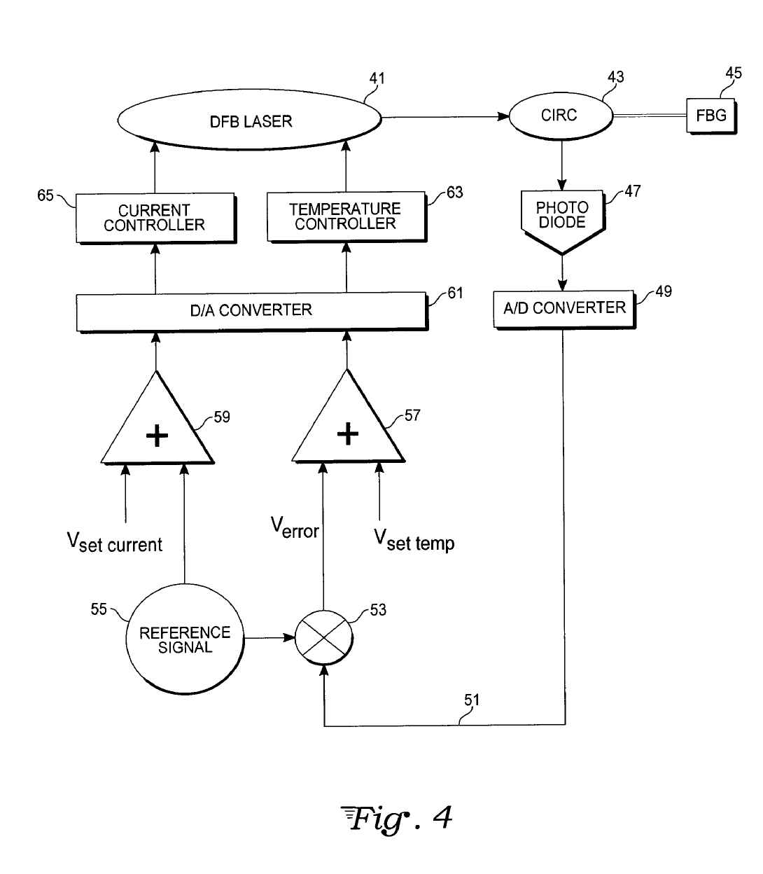

A photodiode 17 or other photodetector is also coupled to receive reflected light from the FBG sensor 15 via the beamsplitter 13. An electrical signal output is transmitted from the photodiode 17 along the conductive line 19 to a lock-in system 21. Here a hardware lock-in amplifier system is used. (FIG. 4 shows a software lock-in system.) The photodiode output is also transmitted along the conductive line 23 to an analog-to-digital converter 25. The converted digital value of the photodiode output is used as a control input 27 to the lock-in device 21 and is also fed to a computer 29. The lock-in amplifier's output 29 provides a feedback signal to control the wavelength of DFB laser 11. This allows the laser 11 to be continuously tuned to the mid-reflection wavelength of the Bragg grating 15 to produce the highest signal-to-noise ratio for the photodiode 17.

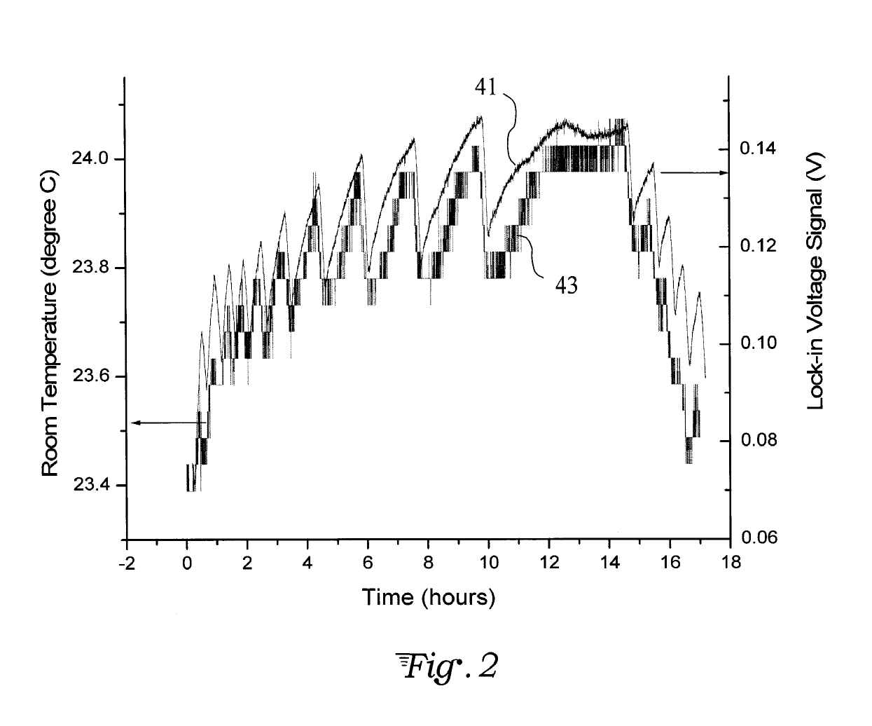

To demonstrate the invention, a commercial FBG sensor 15 was bonded to a composite test plate 31. Light from a DFB laser 11 was locked to the mid-reflection wavelength of the Bragg grating using a Stanford Research SR530 lock-in amplifier 21. The mid-reflection point is generally the most sensitive for strain and stress measurements. For other measurements, such as the presence of a chemical (via polymer fibers that change reflective index) or an electromagnetic field (via the Faraday effect), the selected lock-in point might be on one slope of the reflector spectrum. For comparison purposes, the ambient temperature was also monitored using a Thorlabs TEC2000 temperature monitor. Over a time period of 17 hours, both the FBG sensor and the temperature sensor were exposed to room temperature fluctuation, and the error signal from the lock-in amplifier 21 and the room temperature data were recorded by a desktop computer 29 using two channels from a National Instrument PCI-6111 data acquisition board and LabView software. FIG. 2 shows the lock-in error signal 41 and room temperature signal 43 as a function of time. The lock-in signal 41 clearly demonstrated a superior signal-to-noise ratio compared to that of the Thorlabs temperature sensor. The near periodic fluctuation in the recorded signals were due to the room temperature fluctuation cycle with a period between 30 minutes to two hours.

From time t=0 to t=17 hours, the Thorlabs sensor recorded a temperature shift of 0.713° C. Using the commonly published FBG intrinsic temperature sensitivity value, Δλ_{B}/ΔT=9 pm/° C. [A. Othonos and K. Kalli, “Fiber Bragg Gratings: Fundamentals and Applications in Telecommunications and Sensing”, Artech House, Inc., 1999], this temperature shift induces a thermal strain in the FBG which corresponds to a wavelength shift of 6.4 pm. During this time, the lock-in amplifier 21 registered a changed voltage signal ΔV(t)=69.8 mV, with a noise level of approximately 0.7 mV, corresponding to a signal-to-noise ratio (SNR) of 100:1 and a temperature-induced strain resolution of 0.06 με.

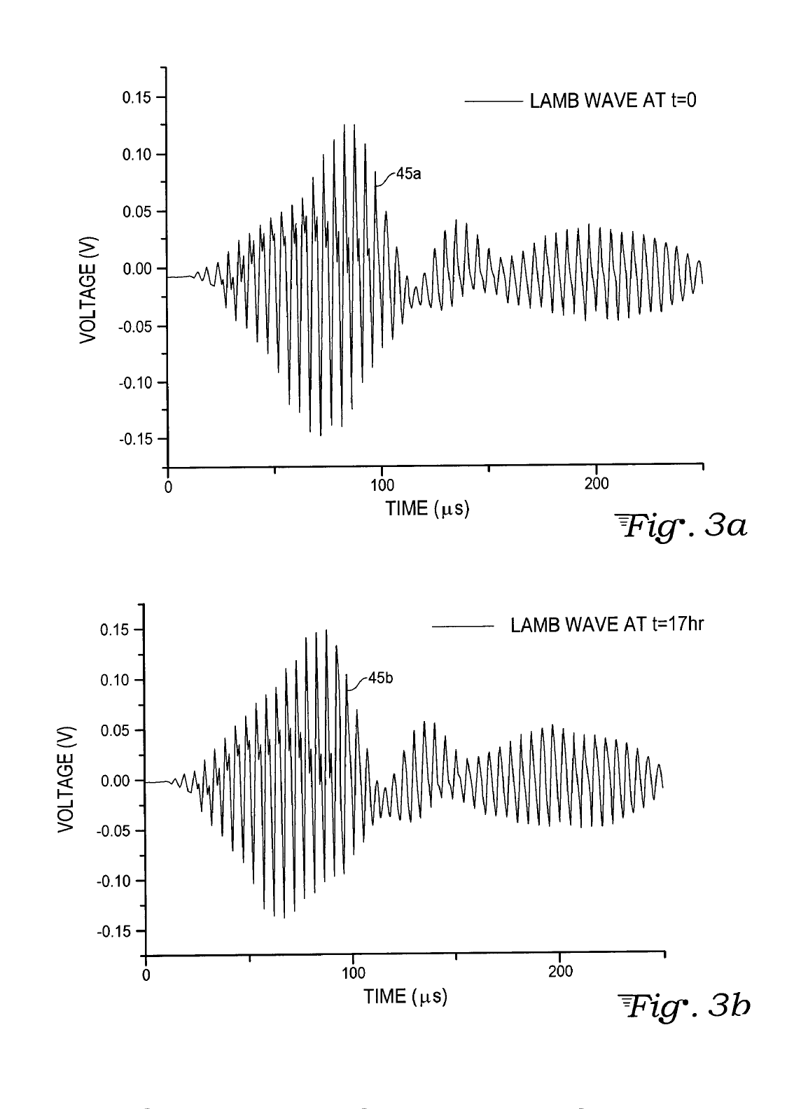

To demonstrate the capability of the lock-in technique for simultaneous measurement of both strain and ultrasonic wave signals, while the laser was still locked to the mid-reflection wavelength of the Bragg grating, ultrasonic waves at 200 kHz were launched into the composite plate 31 using a commercial pulser system from Physical Acoustic Corporation including a PAC S-9208 PZT actuator 33 and a PAC ARB-1410-150 waveform generator 35 with a 10-cycle sine burst signal input. The stress wave signals were collected by the same photodetector 17 that was used to record the thermal strain signal. The digitized data were averaged 100 times, plotted by a LabView program, and saved in the desktop computer 29 for further data analysis. FIGS. 3a and 3b compare the detected stress wave signals 45b and 45b at t=0 and t=17 hours, respectively. The high SNR, reproducible stress wave signal 45b after 17 hours of laser locking in FIG. 3b demonstrates that robust, high resolution strain and high sensitivity acoustic wave signals can be simultaneously measured by the same Bragg grating sensor using the laser-based lock-in demodulation technique.

With reference to FIG. 4, a software-based lock-in system for grating sensing applications is shown. As in the hardware lock-in system of FIG. 1, a wavelength-tunable light source, such as DFB semiconductor laser 41, is optically coupled to a grating reflector, such as an optical fiber with a Bragg grating 45 formed therein. A photodetector, such as the photodiode 47, receives the reflected light from the grating reflector e.g., via a beamsplitter 43. The photodiode 47 produces a signal output corresponding to the received light intensity which is then converted into digital form 51 using an analog-to-digital converter 49.

A software demodulator 53 performs the lock-in function. The basic operating principle behind the software-based lock-in system is similar to its hardware counterpart. The (digitized) modulated AC signals 51 are compared with a reference signal 55 and the resulting demodulated error signal Vₑᵣᵣₒᵣ is used as a feedback to the laser or other light source 41 to facilitate tracking of its wavelength output to a preset position of the grating's changing reflection spectrum. In terms of implementation and performance, the software lock-in system offers a number of advantages over the hardware lock-in amplifier. Since the software performs the actual demodulation process, the lock-in amplifier hardware is unnecessary, resulting in lower costs. The software is scalable to multiple channels with ease, with the same software being used with minimal modification to carry out multi-channel lock-in, so additional channels do not include the cost of additional lock-in amplifiers. The software is easily modified to accommodate different gains, frequency responses and other settings, as well as carry out additional algorithms.

Software generates a periodic, typically sinusoidal, reference signal (100 Hz to 50 kHz). This is numerically added (59) to V_{set current}, the average operating laser current voltage. The sum is connected to a Digital-to-Analog (D/A) converter 61, and the analog output drives the current controller 65 of the DFB laser 47. In addition to demodulating the signal, the software also provides necessary integration, gain, and offset voltage. The resulting error signal Vₑᵣᵣₒᵣ is added (57) to V_{set temp}, the operating laser temperature voltage. The sum is connected to a D/A converter 61, the analog output of which drives the temperature controller 63 of the DFB laser 41. In this fashion, the error voltage Vₑᵣᵣₒᵣ constantly tracks the change in FBG wavelength and corrects the laser 41 accordingly. In addition to locking the laser to the grating 45 the error voltage also accurately measures the environmental parameters that induce change in FBG, including but not limited to temperature, strain, and pressure.

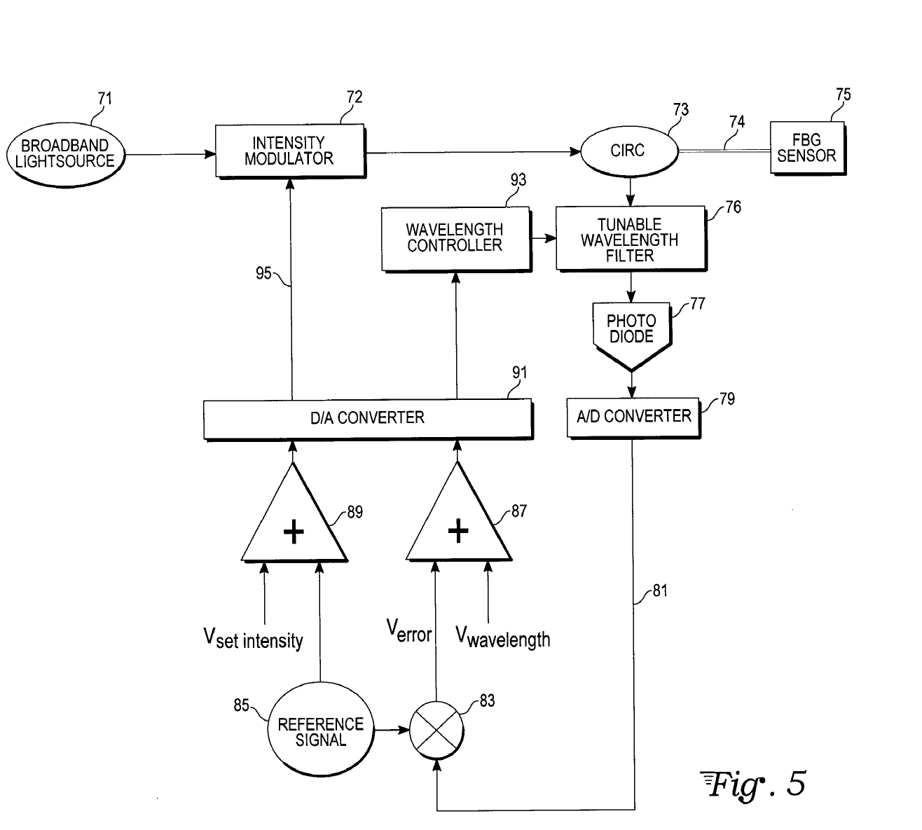

With reference to FIG. 5, a lock-in system for grating sensing applications is shown with a broadband light source 71. The basic operating principle behind a broadband light source based system is similar to its single wavelength (tunable laser) counterparts (cf., FIGS. 1 and 4). However, a difference from the tunable laser embodiments lies in the manner of carrying out the modulation and feedback. In this broadband system, the light source 71 is intensity modulated by an external modulator 72, and the feedback error signal Vₑᵣᵣₒᵣ for each channel is fed into its respective tunable wavelength filter 76, which preferentially transmits the light within its narrow wavelength band. A system with a single broadband source has a scalability and cost advantage in that it can be used for many more wavelength channels compared to the generally more limited tuning range and single wavelength-at-a-time in tunable laser based systems. The broadband source can be used either in a system with a hardware lock-in amplifier as in FIG. 1, or with a software system as in FIG. 4, but due to advantages of scalability and low cost, the software version is preferred and is shown in FIG. 5.

The broadband light source 71 is intensity modulated by an external modulator 72 and the modulated light is then coupled to a feedback grating sensor 75 e.g., via a beamsplitter 73 and optical fiber 74. As in the other lock-in system embodiments, the sensor 75 could be either a fiberoptic Bragg reflector or a surface relief grating. The reflected light passes through a tunable wavelength filter 76 and is received by a photodiode detector 77. The detector 77 produces a signal output that corresponds to the received light intensity of the filter-selected wavelength. The photodiode signal is converted into digital form using an analog-to-digital converter 79.

A software demodulator 83 performs the lock-in function. In particular, the (digitized) modulated AC signal 81 is compared with a reference signal 85 and the resulting demodulated error signal Vₑᵣᵣₒᵣ is used as feedback to facilitate tracking of the grating sensor's changing spectrum to a preset position by the tunable wavelength filter 76. The reference signal 85 is typically a software-generated periodic sinusoidal signal of from 100 Hz to 50 kHz. By comparing the reference signal 85 and the modulated digital signal 81, the modulated signal 81 is demodulated by the software demodulator 83. In addition to demodulating the signal, the software provides integration, gain, and offset voltage. The resulting error signal Vₑᵣᵣₒᵣ is added, 87, to a Vₛₑₜ_{_{—}}_{wavelength}, the nominal operating voltage for the tunable wavelength filter 76. The sum is supplied to a digital-to-analog converter 91, the analog output of which governs a wavelength controller 93 that drives the tunable filter 76. In this fashion, the error voltage Vₑᵣᵣₒᵣ continually tracks the change from the grating's wavelength and corrects the tunable filter 76 accordingly such that center wavelength of the filter 76 is always “in sync” with the grating sensor 75.

The reference signal 85 is also numerically added, 89, to Vₛₑₜ_{_{—}}_{intensity}, the set voltage for the external intensity modulator 72. The sum is supplied to a digital-to-analog converter 91 and the analog drives the intensity modulator.

The broadband system can be readily scaled up to multiple (N) channels by simply including N tunable filters like filter 76, all optically coupled to the grating sensor 75. The detected signal for each filter would be locked in separately from the others using its own demodulator feedback and wavelength controller.

Similar to the single wavelength case, the error voltage Vₑᵣᵣₒᵣ, in addition to locking the filter 76 to the grating sensor 75, also accurately measures the environmental parameters that induce changes in the sensor's grating, including but not limited to temperature, strain, and pressure.

In addition to strain and ultrasonic wave detection, the technique can be applied to high sensitivity temperature, stress, acoustic emission, corrosion monitoring, pressure sensing, chemical sensing, and electromagnetic field (or current) sensing. Other potential applications include wavelength locker for long-term laser wavelength stability in telecommunication applications.

1. A method for optical interrogation of a grating sensor, comprising:
coupling light from a light source to a grating reflector characterized by a reflection spectrum dependent upon environmental conditions;
receiving reflected light of a selected wavelength from the grating reflector by a photodetector, the photodetector producing an electrical signal output corresponding to light intensity;
supplying the electrical signal output from the photodetector to a lock-in system producing a lock-in error signal representing any deviation of the reflection spectrum of the grating reflector;
feeding back the lock-in error signal so as to retune the selected reflection wavelength received by the photodetector in a manner that tracks any changes in the reflection spectrum of the grating reflector; and
using the lock-in error signal as a measure of environmental conditions upon the grating reflector.

2. The method as in claim 1, wherein the light source is wavelength tunable and the light therefrom is tuned by the lock-in error signal relative to a selected reflection wavelength of the grating reflector.

3. The method as in claim 2, wherein the wavelength-tunable light source is a semiconductor laser.

4. The method as in claim 3, wherein the wavelength is tuned by temperature control of the laser.

5. The method as in claim 3, wherein the wavelength is tuned by control of current applied to drive the laser.

6. The method as in claim 2, wherein the wavelength of the light source is continually dithered about the selected reflection wavelength.

7. The method as in claim 1, wherein the light source is an intensity modulated broadband source and reflected light from the grating reflector is received by the photodetector through a tunable wavelength filter, the filter being tuned by the lock-in error signal relative to a selected reflection wavelength of the grating reflector.

8. The method as in claim 1, wherein the light from the light source is coupled to the grating reflector through a beamsplitter and an optical fiber and the reflected light from the grating reflector is received by the photodetector through the optical fiber and the beamsplitter.

9. The method as in claim 1, wherein the grating reflector is a Bragg grating formed in an optical fiber.

10. The method as in claim 1, wherein the grating reflector is a surface-relief grating.

11. The method as in claim 1, wherein the lock-in system comprises a hardware lock-in amplifier.

12. The method as in claim 11, wherein the electrical signal output of the photodetector is also converted to digital form for control of the hardware lock-in amplifier.

13. The method as in claim 1, wherein the lock-in system comprises a software demodulator.

14. The method as in claim 1, wherein the environmental conditions measured by the lock-in error signal produced by the lock-in system include any of the changes in temperature, pressure, electromagnetic field, strain, and presence of specified chemical species.

15. The method as in claim 1, wherein vibrations and ultrasonic stress waves are measured directly by the electrical signal output from the photodetector.

16. A grating sensor, comprising:
a light source;
a grating reflector characterized by a reflection spectrum dependent upon environmental conditions, the grating reflector optically coupled to receive light from the light source;
a photodetector optically coupled to receive reflected light of a selected wavelength from the grating reflector, the photodetector producing an electrical signal output corresponding to light intensity; and
a lock-in system connected to receive the electrical signal output from the photodetector, the lock-in system producing a lock-in error signal representing any deviation of the reflection spectrum of the grating reflector, the lock-in voltage error signal being coupled as a feedback so as to retune the selected reflection wavelength received by the photodetector in a manner that tracks any changes in the reflection spectrum of the grating reflector, the lock-in error signal also being an output serving as a measure of environmental conditions upon the grating reflector.

17. The grating sensor as in claim 16, wherein the light source is wavelength tunable by the lock-in system to a wavelength relative to a selected reflection wavelength of the grating reflector.

18. The grating sensor as in claim 17, wherein the wavelength-tunable light source is a semiconductor laser.

19. The grating sensor as in claim 18, wherein the semiconductor laser has temperature-controlled wavelength tuning.

20. The grating sensor as in claim 18, wherein the semiconductor laser has drive current-controlled wavelength tuning.

21. The grating sensor as in claim 16, wherein the light source is an intensity modulated broadband source and further comprising a tunable wavelength filter positioned in front of the photodetector so as to select the wavelength received by the photodetector, the filter being tuned by the lock-in system to a wavelength relative to a selected reflection wavelength of the grating reflector.

22. The grating sensor as in claim 16, further comprising an optical fiber positioned to optically couple the grating reflector to the light source and to the photodetector.

23. The grating sensor as in claim 16, wherein the grating reflector is a Bragg grating formed in an optical fiber.

24. The grating sensor as in claim 16, wherein the grating reflector is a surface relief grating.

25. The grating sensor as in claim 16, wherein the lock-in system comprises a hardware lock-in amplifier.

26. The grating sensor as in claim 25, wherein the lock-in system further comprises an analog-to-digital converter coupled to receive the electrical signal output of the photodetector, the analog-to-digital converter connected to supply a digital form of the electrical signal output to the lock-in amplifier as a control.

27. The grating sensor as in claim 16, wherein the lock-in system comprises a software demodulator.

28. The grating sensor as in claim 16, wherein the environmental conditions measured by the lock-in voltage error signal produced by the lock-in amplifier include any of the changes in temperature, pressure, electromagnetic field, strain, and presence of specified chemical species.

29. The grating sensor as in claim 16, wherein vibrations and ultrasonic stress waves are measured directly by the electrical signal output from the photodetector.
